(19) United States
(12) Patent Application Publication
(10) Pub. No.: US 2021/0065293 A1
(43) Pub. Date: Mar. 4, 2021

(54) DISTRIBUTED LEDGER LENDING

(71) Applicant: THE LENDINGCOIN, INC., Boise, ID (US)

(72) Inventors: Phil Sigler, Meridian, ID (US); Ian Michael Smith, Boise, ID (US)

(21) Appl. No.: 16/554,631

(22) Filed: Aug. 29, 2019

(51) Int. Cl. G06Q 40/02; H04L 9/06; G06Q 20/10

(52) U.S. Cl. CPC G06Q 40/025; H04L 9/0637; H04L 2209/56; G06Q 20/102; H04L 2209/38; H04L 9/0643

(57) ABSTRACT

Methods and processes can include disbursement and/or management of loans or other obligations via a distributed digital ledger system. In embodiments, smart contracts may be instantiated to reflect issued loans and to reflect repayment obligations therefor. In one embodiment, a lending entity loans money in the form of fiat currency (or other currency type) to a borrower. As the borrower repays the loan, equivalent payments may be made to a digital wallet that is associated with the smart contract, thereby causing the smart contract to evaluate that particular repayment obligation as satisfied.

### BACKGROUND

The present disclosure generally relates to distributed ledger computer systems. More particularly, the present disclosure relates to computer systems and processes for providing, administering, and/or managing loans using blockchain technology.

Ether is one example of a cryptocurrency which is transacted on a secure decentralized ledger that is distributed throughout its open network. This decentralized ledger is known as the blockchain and it allows participants in the network to transact ether without the need for a trusted third party, such as a bank. The blockchain is generated and distributed by Ethereum, a distributed computing platform and operating system. The Ethereum platform is one of several cryptocurrency platforms that provide for the formation and execution of smart contracts and for running blockchain applications.

The blockchain is a data structure that stores a list of transactions, forming a distributed electronic ledger that records transactions between source identifiers and destination identifiers. The transactions are bundled into blocks and every block (except for the first block) refers back to or is linked to a prior block in the chain. Computer nodes maintain the blockchain and cryptographically validate each new block and the transactions contained therein. The integrity of the entire blockchain (i.e., confidence that a previously recorded transaction has not been modified) is maintained because each block refers to or includes a cryptographic hash value of the prior block. Accordingly, once a block refers to a prior block, it becomes difficult to modify or tamper with the data (i.e., the transactions) contained therein. This is because even a small modification to the data will affect the hash value of the entire block. Each additional block increases the difficulty of tampering with the contents of an earlier block. Thus, even though the contents of a blockchain may be available for all to see, they become practically immutable.

Decentralized applications can be run on certain cryptocurrency platforms using blockchain technology. A decentralized application is an application that can serve a specific purpose. Such decentralized applications do not depend on any specific party or centralized intermediary to function as desired and/or expected. As a globally executed virtual machine, the blockchain platform essentially has a built-in programming language, which may be considered a large decentralized computer.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram illustrating a lending system according to an embodiment of the present disclosure;

FIG. 2 is a block diagram illustrating a blockchain node communication scheme in accordance with embodiments of the present disclosure;

FIG. 3 is a block diagram illustrating an example of a system for providing interfaces to investors and borrowers in accordance with embodiments of the present disclosure;

FIG. 4 is a flow chart illustrating an example method for loan origination in accordance with embodiments of the present disclosure; and

FIG. 5 is a flow chart illustrating an example method for loan repayment in accordance with embodiments of the present disclosure.

Corresponding reference characters indicate corresponding components throughout the several views of the drawings. Skilled artisans will appreciate that elements in the figures are illustrated using common modeling techniques for simplicity and clarity and are not inclusive of all features or components.

### DETAILED DESCRIPTION

The present disclosure is directed to methods, systems, and computer programs for enabling decentralized loans that are transacted via a distributed ledger computer system. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the descriptions, alternatives proposed, or the spirit and scope of the present disclosure. The following detailed description is not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art.

In one embodiment according to the present disclosure, a process for transacting and/or executing a decentralized loan process via a digital distributed ledger carried out on a distributed ledger computer system includes one or more applications, such as software packages, modules, or systems, implemented on one or more computing systems.

As used herein, the term “computing system” includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player; an Internet appliance; a dedicated microprocessor; or any device that includes components that can execute all, or part, of any one of the processes and/or operations as described herein. In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; dedicated microprocessors; and/or any devices that can be used to perform the processes and/or operations as described herein. A computing system can also denote logical computing, such as a group of atoms, computers, or other state tracking systems that perform calculations in a Turing-complete manner for purposes of acting as a computing platform

In the present disclosure, a digital distributed ledger may also be referred to as a blockchain. Herein, the term “blockchain” includes, but is not limited to, a series of linked records stored on multiple nodes in a digital distributed ledger system. Said records may be referred to as “blocks.” Specific illustrative examples of records in a blockchain may include a cryptographic hash of a previous record, which may allow the records to be linked in an ordered and immutable series. Additional specific illustrative examples of records in a blockchain may include a timestamp corresponding to the record. Additional specific illustrative examples of records in a blockchain may include transaction data. Under the scope of the current disclosure, blockchain records may include additional data as discussed herein, and/or as known in the art at the time of filing, and/or as developed after the time of filing. Distributed ledger technology which uses a consensus system but does not create specific ordered blocks may be referred to herein as a “blockchain” even if the technology does not number or describe blocks. Said “blockchains” of the present disclosure may be characterized by a series of distributed hash calculations which form a secure network in a distributed ledger as a computing platform, record keeping system, and record distribution system.

In one embodiment, one or more computing systems are connected by one or more communications channels, such as, but not limited to: any general network, communications network, or general network/communications network system; a cellular network; a wireless network; a combination of different network types; a public network; a private network; a satellite network; a plain old telephone service (“POTS”) network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (“LAN”), a Wide Area Network (“WAN”), a public network, such as the Internet, a private network, a cellular network, a POTS network; any general network, communications network, or general network/communications network system; a wireless network; a wired network; a wireless and wired combination network; a satellite network; a cable network; a Virtual Private Network (“VPN”), a Mesh Network (or other many-to-many system); a cryptographic Directed Acyclic Graph (“crypto DAG”); any combination of different network types; or any other system capable of allowing communication between two or more computing systems, whether available or known at the time of filing or as later developed. Some common embodiments may typically comprise an “Internet Protocol” address system and a distributed ledger technology system using cryptographic addresses as end points, but the scope of the present disclosure is not restricted to such. A person of ordinary skill in the art having the benefit of the present disclosure would understand that an address system can be used on multiple network types; for example Ethereum's DLT technology running Ropstein, Mainnet, Casper, Kovan, Rinkeby, Goerli and Rinkeby networks.

Embodiments of the present disclosure comprise a system for enabling loans that are transacted via a distributed ledger network. On the distributed ledger system, smart contracts can be created and recorded to memorialize said loans, record liens and other security interests, record promissory note, transact loan repayments, and/or record loan satisfaction. Some embodiments comprise loan servicing and recording loan payments on a distributed ledger network. Some embodiments comprise collection of loan payments and the distribution thereof for loan settlement as repayment.

According to embodiments of the present disclosure, a peer-to-peer collateralized mortgage portfolio is owned by one or more shareholders of a lending entity, in which the shares are represented as digital tokens. As with other digital token platforms, ownership of said digital tokens, and therefore shares of the collateralized mortgage portfolio, may be transferred from one digital wallet to another and memorialized on a distributed electronic ledger. This electronic ledger resides on the blockchain and, as such, may be immutable and accessible at any node on the blockchain network.

In one embodiment, a lending entity may approve prospective borrowers based on creditworthiness or other factors as may be desirable. In some embodiments, one or more borrowers are selected according to predetermined criteria. For example, in one embodiment, a mortgage portfolio may comprise loans that are limited to loans for commercial real estate. In one embodiment, a mortgage portfolio may comprise loans that are limited to loans for residential real estate. In one embodiment, a mortgage portfolio may comprise loans for both commercial real estate and residential real estate. In one embodiment, a portfolio comprises loans for business enterprises, personal expenses, and/or a variety of other purposes. In other embodiments, other types of loans may be transacted.

In embodiments, the lending entity may use criteria for selecting borrowers similar to criteria currently in use for traditional financing operations. For example, the lending entity may consider loan-to-value ratio, debt-to-income ratio, credit score, or other factors relevant to the loan risk. In other words, potential loans may be analyzed and considered in a manner similar to that of a conventional lending operation.

Upon approving a borrower, the lending entity may disburse the loaned amount to the borrower(s) in the form of fiat currency, for example in U.S. dollars. Upon loaning said money, a smart contract may be initialized to memorialize the loans. In one embodiment, the smart contract record includes the principal balance, a link to a deed, deed of trust, mortgage agreement, and/or other security instrument for the relevant collateral, repayment information, and digital wallet identification(s) for the lender and borrower.

In embodiments, a reference to a deed, deed of trust, mortgage agreement, and/or other security instrument comprises a unique reference to one or more original documents by cryptographic hash. The hash is mathematically generated, wherein each document may generate a new cryptographic hash. In one example, 2¹⁶⁰ variations may be considered secure. In other examples, a secure system may use 2²⁵⁶ or more possible hashes. The particular hash method used is not relevant to the present disclosure, as the state of the art may rapidly change in this regard and the cryptographic hash technique utilized does not affect the utility of the methods, underlying processes, or techniques disclosed herein. In embodiments, a hyperlink to a data and/or file storage facility where the security instrument(s) or other documents are maintained can include the cryptographic hash. In one embodiment, said documents are uploaded at the time of loan origination. In embodiments, the reference hash or link being publicly accessible by an immutable distributed ledger technology may create a trustworthy declaration that no longer relies on reputation for maintenance.

In order to manage cryptographic access to funds or permissions to data, a Wallet can be created. A Wallet is essentially a variable to the blockchain, but for the Wallet software, a series of complicated cryptographic methods may be used. A public/private key system may be used in many implementations as an elliptical curve of form secp256k1 (x²=y³+7). A random string of bits can be generated, and a calculation may optionally be performed to determine if the string of bits exists as a point on the elliptical curve. If the random string of bits is on the curve, it may be saved as the user's private key. In one embodiment using secp256k1, a public key is generated by finding a line that intersects the elliptical curve through two points, which are then checked before being saved as the public key. The private key in many embodiments may be saved using AES encryption, with a key store and a mnemonic phrase for recovery. The public key may then be hashed using a one-way cryptographic hash such as SHA256, SHA3, SHA3-Keccak, or one of many other variants.

As described above, loan repayment information may be included in the smart contract for a loan. The smart contract may be executed by the blockchain virtual machine according to the loan agreement. In various examples, repayment information may include a repayment schedule and/or amortization information for the loan. As payments are made according to the repayment schedule set forth in the smart contract, they can be recorded in the blockchain ledger to thereby reflect each repayment transaction. In various embodiments, loans can be tracked by wallet, by non-fungible token (“NFT”), smart contract or smart subcontract.

As used in the present disclosure, a smart contract comprises a Turing complete set of instructions that executes when a certain condition is met, typically a trigger of a transaction. Some embodiments of smart contracts have internal and external methods of triggering execution. The set of instructions that follows the trigger can be generated as a transaction in the blockchain. A blockchain transaction typically involves the movement of data, which may be the blockchain native coin or currency used for accounting relative value within the chain. The instructions for such a transaction may have a “halting problem,” wherein the instructions do not terminate within a certain boundary of time. In order to prevent or mitigate the Halting Problem, Ethereum (and many other implementations) used a “Gas” cost, which charged the native coin for performing transactions, a cost per byte transferred, and a cost per byte stored.

In some embodiments, the Distributed Ledger Technology uses a different address system for designating wallet addresses than smart contract addresses. In other embodiments, the Distributed Ledger Technology has an identical address system for Smart Contract and Wallet Addresses. When payments are made to a loan-specific digital address they may be either Wallet Addresses or Smart Contracts. In some discussions of the present disclosure a Wallet Address or a Smart Contract may be used, and the phrase “digital address” encompasses both Wallet and Smart Contract.

One common data type in smart contracts is “tokens,” which are variables inside the smart contract. Tokens are typically transferable and can represent obligations (debt) or value (assets). In some embodiments of the present disclosure, the tokens represent an amount owed by a borrower. In other embodiments, tokens represent fiat currency and denominations of tokens comprise a tracking mechanism for national currency. In other embodiments, tokens represent an arbitrary store of value. In various embodiments, tokens represent financial obligations between parties, which may include some or all of: investors, borrowers, servicing parties, settlement parties, loan origination, credit agencies, Non-Fungible Token as ownership, Non-Fungible Token as owner, Non-Fungible Token as asset, fractional ownership pools, promissory note holders, government agencies, regulatory bodies, etc. One embodiment of a Non-Fungible Token comprises unique data matching a unique item. A Fungible Token is one that claims a particular quantity of tokens, which all have identical structure and form, as belonging to a wallet. A Non-Fungible Token specifies a particular token (e.g. “TOKEN ‘XYZABCD123513’”) as belonging to a wallet.

According to various embodiments of the present disclosure, settlement in blockchain may be performed within the time frame that the blocks are mined and declared. The blockchain miner selects which transactions they wish to mine and declares them to the chain by listing them inside a block as having occurred. As examples, the Ethereum blockchain uses a block time of fifteen seconds, while Bitcoin uses a block time of several hours. Settlement is concluded at the time of publishing the block, but there may be no guarantee as to the time to process a transaction; rather there may be an economic incentive (see “Gas” as described above) to perform the transaction. Miners can be economically motivated under typical cryptocurrency schemes, and so are other actors in the system under Proof of Stake or various alternatives or hybrids. Settlement may be considered performed when the block is published.

When the block is published, it may contain a series of hash entries in a Merkle tree or similar data structure (alternatively, a Directed Acyclic Graph). The publishing of blocks in blockchain is considered irrevocable settlement, and for the specific purposes of the present disclosure, this settlement may replace a traditional process of extending credit and/or creating a commitment (which may or may not be finalized). In a non-permissioned blockchain, the methods of defeating a transaction are equivalent to a “51% attack,” wherein the longest chain wins a disagreement. In common practice, the blocks are aged by waiting until the subsequent 2-50 blocks are published (depending on implementation) before they are treated as true. Some embodiments of the present disclosure follow a similar principle and match or exceed the commonly accepted value for a specific chain.

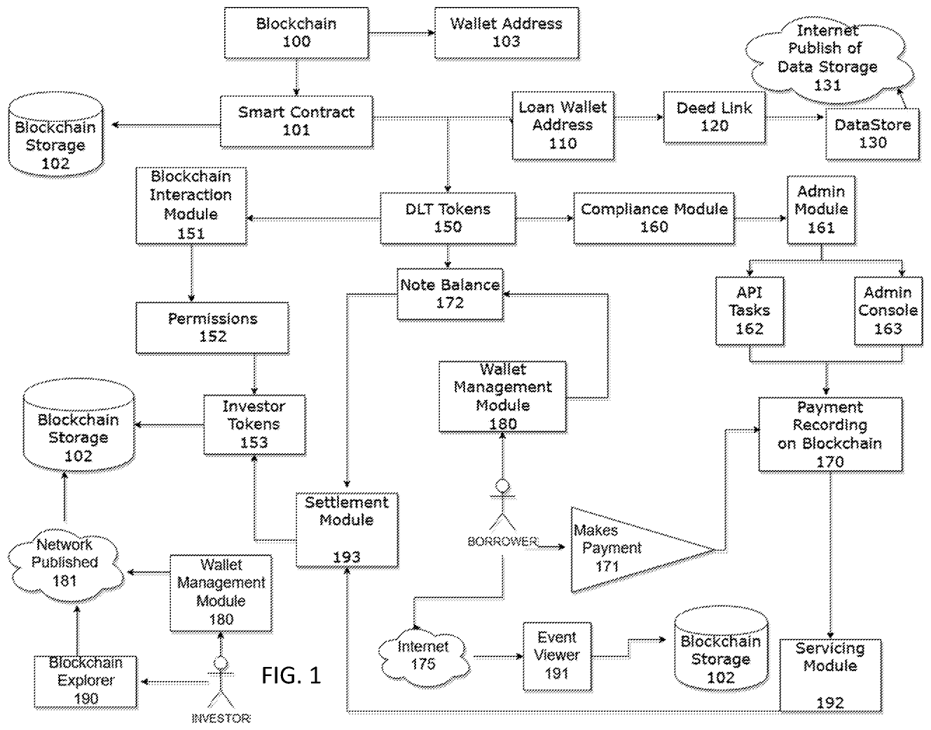

FIG. 1 is a block diagram depicting a blockchain lending system and process according to embodiments of the present disclosure. It is to be understood that some embodiments of the present disclosure do not include all systems or methods depicted in FIG. 1. As depicted in FIG. 1, embodiments of the present disclosure include an implementation of distributed ledger technology that includes a plurality of nodes, a SMART CONTRACT 101 execution system for automated transactions, and a series of cryptographic techniques as described above for WALLET ADDRESS 103, which is managed by WALLET MANAGEMENT MODULE 180. As described above, the loan can exist as a SMART CONTRACT 101, a sub implementation of SMART CONTRACT 101, or at a LOAN WALLET ADDRESS 110. The SMART CONTRACT 101 implementation can implement a system as described by DLT TOKENS 150 and WALLET MANAGEMENT MODULE 180 functions. In one embodiment, a plurality of LOAN WALLET ADDRESS 110 exist for a single loan, and in other implementations a SMART CONTRACT 101 replaces the LOAN WALLET ADDRESS 110. Preferably, one implementation of the WALLET MANAGEMENT MODULE 180 allows either implementation to exist on multiple BLOCKCHAIN 100 technology implementations.

Once a loan has passed the compliance and credit worthiness to validate a prospective borrower, a series of documents are prepared to memorialize the loan agreement. Said documents may be prepared in accordance with local regulations. In various embodiments, said documents may include loan/promissory notes or other types of loan contracts, deeds, deeds of trust, mortgage agreements, warranty documents, security interests to a real property, structured payment systems represented by a note or contract, recurring payment obligations, recurring payment receivables, cyclical payment structures, asset purchases by structured payment, structured rewards as recurring payments, loans based on payment percentage or sales receipt obligations, issued notes, or other types of security instruments, and/or additional legal documents memorializing an issued loan as discussed herein, and/or as known in the art at the time of filing, and/or as developed after the time of filing. Such documents may be referred to herein as loan instruments.

In embodiments of the present disclosure, loan instruments may be signed and prepared in document format. In one embodiment, said executed loan instruments are digital scans of paper documents that were hand-signed before scanning and converting to a digital file format such as Portable Document Format (“PDF”), Tagged Image File Format (“TIFF”), and/or other file formats as discussed herein, and/or as known in the art at the time of filing, and/or as developed after the time of filing. In another embodiment, executed loan instruments exist only as digital files, which are signed digitally before uploading to a third-party database.

In various embodiments, the loan instrument can be any hard copy and/or digital copy of a document or agreement relating to a loan. In one embodiment, the loan instrument is obtained as electronic data via, as illustrative examples, e-mail or the Internet. In other embodiments, the loan instrument can be any electronic form of document, including a document generated from a paper document or a document that originated in a digital form. An electronic form of a loan instrument can include, but is not limited to, a Portable Document Format (“PDF”) file with or without embedded text, an image file depicting a loan instrument, a word-processing document file, or any other electronic file, as discussed herein, and/or as known in the art at the time of filing, and/or as developed after the time of filing.

Within the software systems depicted in FIG. 1 a loan transaction can be deployed to a blockchain using a plurality of systems. In embodiments, ADMIN MODULE 161 contains API TASKS 162 accessed through ADMIN CONSOLE 163 which constitutes an alternate BLOCKCHAIN INTERACTION MODULE 151 to interface with SMART CONTRACT 101, in which the administrator with an administrative-permissioned WALLET ADDRESS 103 uses a private key to authenticate.

When deploying the loan transaction to the blockchain, the LOAN WALLET ADDRESS 110 can be targeted by the SMART CONTRACT 101. In various embodiments, the data published in the blockchain record comprises the hash or component aspect of DEED LINK 120 referenced on DATA STORE 130. In some embodiments, INTERNET PUBLISH OF DATA STORAGE 131 is carried out. In other embodiments, the DEED LINK 120 on DATA STORE 130 hash inside BLOCKCHAIN STORAGE 102 is sufficient for immutable third-party verification. DEED LINK 120 thereby becomes referenced inside LOAN WALLET ADDRESS 110 as a key; in some implementations, successful deployment of the loan to the blockchain may be verified by this key. In other implementations, the INTERNET PUBLISH OF DATA STORAGE 131 could be cross referenced by a plurality of data points to indicate the key information allowing verification of SMART CONTRACT 101 references inside BLOCKCHAIN STORAGE 102.

With reference to BLOCKCHAIN STORAGE 102, various methods of access can be used independently, verifiably, cryptographically, and securely. The BLOCKCHAIN STORAGE 102 can be made public or remain pseudo-anonymous by being a cryptographic needle in a hash space haystack of size 150 bits minimum, but implementations can exceed 256 bits of cryptographic space. As such, the system may be both pseudo-anonymous and verifiable using cryptographic public/private keys and/or hashes in order to reference and verify data.

For the purposes of this disclosure, the SMART CONTRACT 101 may implement a plurality of methods to both protect and reveal information as necessary, with the main reference point being either a plurality of sub smart contracts (not depicted in FIG. 1) or LOAN WALLET ADDRESS 110 performing identical functions for organizing a collection of information about the loan on BLOCKCHAIN 100.

In one embodiment, COMPLIANCE MODULE 160 is integral to the system. In another embodiment, COMPLIANCE MODULE 160 is optional to the system. Embodiments of COMPLIANCE MODULE 160 could be maintained by a single trusted entity with access to all functions permitted by SMART CONTRACT 101 as owner of that contract, but the access of administrator may be limited by the functions declared therein. There may be no edit or undo capability provided by SMART CONTRACT 101; therefore, the COMPLIANCE MODULE 160 may be implied and can be explicitly or implicitly enforced due to the immutable nature of the cryptographic hash trees built forming BLOCKCHAIN 100. Additional permissions and restrictions can be granted or revoked using COMPLIANCE MODULE 160. In some implementations, these additional permissions and/or restrictions include the ability to limit transfers of tokens, payment windows, payment wallets, payment locations, methods of payment, exchange rate between methods of payment, the generation of new loans, the ability to redeclare an existing loan, the ability to withdraw from LOAN WALLET ADDRESS 110, the ability to MAKES PAYMENT 171 by BORROWER, the methods therein, the allocation of benefits to INVESTOR, the ability for INVESTOR to make additional deposits, withdrawals, transfers, exchanges, etc. These functions may alter the behavior of the parties involved in order to remain legally compliant, hence COMPLIANCE MODULE 160 may effectuate legal compliance of systems of the present disclosure.

Embodiments of ADMIN MODULE 161 may be used to perform some functions related to the loan management and payment recording. One embodiment of ADMIN MODULE 161 comprises a number of components (not depicted in FIG. 1) that may represent methods similar to those used in the current state of the art for financial modeling, tracking, compliance, verification, and transfer methods for financial instruments including but not limited to mortgages, loans, and notes. ADMIN MODULE 161 also represents API TASKS 162, wherein software methods are used to administer SMART CONTRACT 101 in a semi-automated or regulated fashion as created by additional tools. Such tools may assist methods disclosed herein to achieve BLOCKCHAIN 100 speed because of potential interactions between third parties and SMART CONTRACT 101, especially for COMPLIANCE MODULE 160 and exchange methods. API TASKS 162 may enable Application Programmatic Interfaces to administer SMART CONTRACT 101 as part of the systems disclosed herein and to achieve regulatory compliance.

Embodiments of ADMIN CONSOLE 163 comprise a series of administration tasks that in various implementations may have been reduced to either a series of commands issued by the administrator, a series of buttons or other input objects in some Graphical User Interface, a series of buttons or other input objects in some Web Site, or a series of buttons or other input objects in some mobile computing device be it PDA, Cellular Phone, or otherwise as stated elsewhere. Embodiments of ADMIN CONSOLE 163 are adapted to interact with SMART CONTRACT 101, managing BLOCKCHAIN STORAGE 102, and as described further, in conjunction or independently from API TASKS 162, be involved in the PAYMENT RECORDING ON BLOCKCHAIN 170. It may not be necessary for an administrator to push a button or other input object in all implementations, because API TASKS 162 may automate the method of receiving and recording payment from BORROWER. However, it should be noted that in some implementations the necessity of administrator button-pressing and/or console commands through ADMIN CONSOLE 163 may be called for in order to maintain COMPLIANCE MODULE 160 or other regulatory compliance. Additionally, in some implementations, the BORROW can MAKES PAYMENT 171 in fiat currency and not using cryptographic methods, wherein the ADMIN CONSOLE 163 can be used in some manner to thereby declare the PAYMENT RECORDING ON BLOCKCHAIN 170.

After recording a PAYMENT RECORDING ON BLOCKCHAIN 170 has been completed, which may or may not involve DLT TOKENS 150, the NOTE BALANCE 172 can change to reflect the payment. In this manner, both the payment and the remaining balance in the note are maintained in some implementations. Some embodiments include automation, manual verification, and/or manual entry or delay. Additional information about NOTE BALANCE 172 may be declared that includes interest, principal, late fees, normal fees, fiduciary activity, early repayment, amortization, schedules, and/or additional information. All such information can be recorded in either SMART CONTRACT 101 dedicated fields, or as arbitrary data to be correlated in such a manner as chosen by the administrator prior to the declaration of SMART CONTRACT 101 into BLOCKCHAIN 100. Some implementations may include multiple methods of accomplishing the same tasks, while others include selection of only a single route. The maintenance of such material may interchangeably be done through a plurality of pre-selected methods. The limitations of the selections available may typically be determined at the time the SMART CONTRACT 101 is declared, so extra consideration about the capabilities of SMART CONTRACT 101, and proprietary methods of maintaining COMPLIANCE MODULE 160 and PERMISSIONS 152 are critical before declaration of the SMART CONTRACT 101.

In embodiments, PERMISSIONS 152 for the DLT TOKENS 150 may be based on COMPLIANCE MODULE 160 interaction. The regulatory framework selected for implementation may include, but is not limited to: utility token, SEC Regulated Security, Sandbox Compliance, Money Transfer Authority, CFTC regulated Commodity, or other assets, liabilities, notes, and/or fiduciary responsibilities pertaining to other jurisdictions and/or regulatory schemes. Accordingly, embodiments of the present disclosure comprise a PERMISSIONS 152 module for users such as INVESTOR or BORROWER capable of dealing with the different regulatory frameworks, administered with COMPLIANCE MODULE 160 and DLT TOKENS 150. In some embodiments of the present disclosure, INVESTOR TOKENS 153 has a different level of PERMISSIONS 152 than the DLT TOKENS 150. It is to be understood that while INVESTOR TOKENS 153 and DLT TOKENS 150 are drawn separately in FIG. 1, they may be the same “Token” in some embodiments of the present disclosure. Various embodiments disclosed herein have the ability to have separate tokens and/or separate permissions in order to maintain compliance under different legal frameworks due to separation of PERMISSIONS 152 and INVESTOR TOKENS 153 from DLT TOKENS 150, NOTE BALANCE 172, and PAYMENT RECORDING ON BLOCKCHAIN 170.

The access by BORROWER, INVESTOR, and optionally ADMINISTRATOR can be performed through various interaction modules. Embodiments of BLOCKCHAIN INTERACTION MODULE 151 can interact through a series of calls and permission-based roles. Embodiments of WALLET MANAGEMENT MODULE 180 can act upon the blockchain and/or smart contract by means of wallet software, wherein the private key becomes a public key and thereby hashed to form a WALLET, which is granted certain methods and, in some embodiments, may include MAKES PAYMENT 171. Embodiments of the ADMIN MODULE 161 may use the same methods with a heightened-access WALLET, because some software can be used where API TASKS 162 may become input objects that require WALLET based authentication.

Separately from the software modules for interaction, some embodiments of the present disclosure comprise two additional systems wherein the users, BORROWER, INVESTOR, and/or ADMINISTRATOR are capable of viewing information from the BLOCKCHAIN 100 and access BLOCKCHAIN STORAGE 102. In some embodiments, BLOCKCHAIN EXPLORER 190 can present various hexadecimal, binary, base64, base82, or otherwise obfuscated data commingled with optional plaintext information about the performance of the BLOCKCHAIN 100 and potentially SMART CONTRACT 101. One embodiment of a BLOCKCHAIN EXPLORER 190 is a software module that reads all transactions that occur, and/or may potentially occur, on a blockchain and displays the data in some alternate form. BLOCKCHAIN EXPLORER 190, with some assistance from NETWORK PUBLISHED 181, may allow INVESTOR to manage their investment. In one embodiment, said management may be implemented by a WALLET MANAGEMENT MODULE 180. However, some embodiments include the use of BLOCKCHAIN EXPLORER 190 in a wallet-like manner, where INVESTOR uses their private key from the public/private key pair in order to interact with BLOCKCHAIN 100 through NETWORK PUBLISHED 181 information to interact with BLOCKCHAIN STORAGE 102, thereby affecting INVESTOR TOKENS 153. In some cases, INVESTOR TOKENS 153 are managed by INVESTOR without contacting ADMINISTRATOR as long as INVESTOR has sufficient PERMISSIONS 152. The information relevant to the INVESTOR to make decisions about their investment may come from BLOCKCHAIN EXPLORER 190 without contacting LOAN WALLET ADDRESS 110, NOTE BALANCE 172, SERVICING MODULE 192, SETTLEMENT MODULE 193, ADMIN MODULE 161 and/or similar modules or interfaces due to the distributed nature of BLOCKCHAIN 100.

EVENT VIEWER 191 is an alternate method of using INTERNET 175 by INVESTOR, BORROWER, and/or ADMINISTRATOR to check on the actions of SMART CONTRACT 101. At the time of contract publishing, a series of specific events may optionally be declared for public consumption. Such events may be generic or specific, depending on implementation and the specific verbiage of SMART CONTRACT 101. One function of an embodiment of EVENT VIEWER 191 is to announce the behaviors and actions of SMART CONTRACT 101 in ways that are not pseudo-anonymous. As such, the events declared may be for public consumption and EVENT VIEWER 191 can be made obvious to the general public, be indicated only to regulators, or remain an internal only tool. One potential advantage of EVENT VIEWER 191 is that the actions can be in human-readable form without additional work by BLOCKCHAIN EXPLORER 190. Using such information, embodiments of BLOCKCHAIN EXPLORER 190 and third parties could map EVENT VIEWER 191 and internal mechanisms of SMART CONTRACT 101, thereby learning more about the functioning of the loans and business. However, while possible, reverse engineering the SMART CONTRACT 101 by EVENT VIEWER 191 may not be a security concern, but rather a privacy concern, because embodiments of SMART CONTRACT 101, WALLET, and ADMIN MODULES 161 are adapted to be restricted by public/private key.

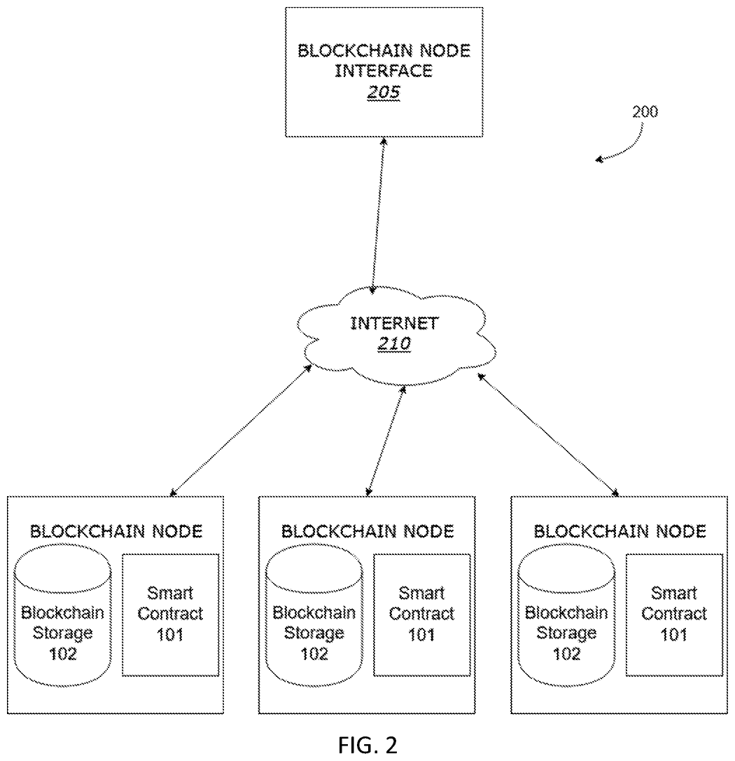

Referring to FIG. 2, an example blockchain communication scheme 200 is depicted. In embodiments of the present disclosure, Blockchain Node Interface 205 can communicate with one or more blockchain nodes 220 via the Internet 210. In other embodiments, Blockchain Node Interface 205 can communicate with blockchain nodes 220 via other types of networks currently known in the art or not yet known in the art. In embodiments, each node on the blockchain (or other types of distributed ledger system) has a copy of all transaction records on the distributed ledger, including the smart contract, any loan transactions, and other records as disclosed herein.

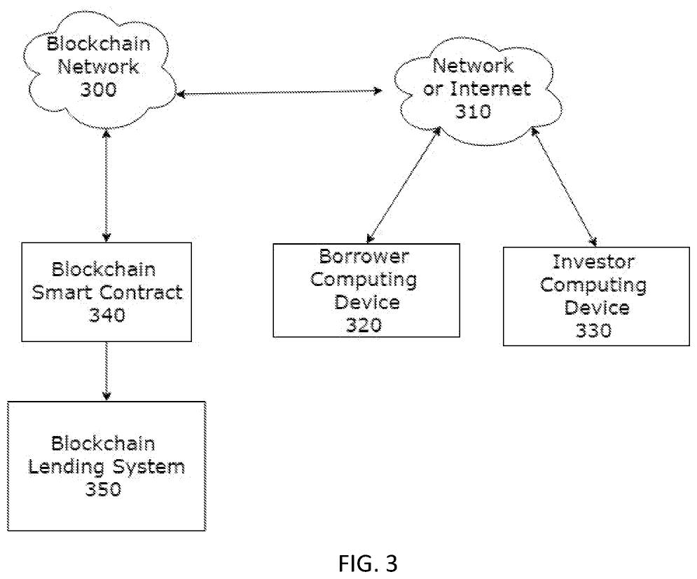

FIG. 3 depicts a communications system 300 wherein BLOCKCHAIN 100 transmits and receives instructions and information to and from BORROWER COMPUTING DEVICE 320 and/or INVESTOR COMPUTING DEVICE 330 over NETWORK OR INTERNET 310. In various embodiments, NETWORK OR INTERNET 310 comprises any of a variety of network types. User devices may include an investor computing device 320 and a borrower computing device 330. BLOCKCHAIN NETWORK 300 can be accessed by LAN or internet in order to interact with BLOCKCHAIN SMART CONTRACT 340. In various embodiments, the security of BLOCKCHAIN SMART CONTRACT 340 and/or BLOCKCHAIN LENDING SYSTEM 350 are approximately as secure as the BLOCKCHAIN NETWORK 300.

In one embodiment, an investor can access BLOCKCHAIN LENDING SYSTEM 350 via NETWORK OR INTERNET 310 on INVESTOR COMPUTING DEVICE 320 to see the balance of INVESTOR TOKENS 153, DLT TOKENS 150 inside in the INVESTOR WALLET ADDRESS 103, to sell or purchase digital tokens, to see the current token value, to view BLOCKCHAIN EXPLORER 190, to view EVENT VIEWER 191 and/or carry out other tasks related to the investment of digital tokens. If authentication is desired, INVESTOR access method can use the public/private key system, but it is possible in various embodiments to create a username and password system that would allow access by either BLOCKCHAIN EXPLORER 190 or EVENT VIEWER 191 to view the INVESTOR balance. In one embodiment, the BORROWER and/or INVESTOR can access a portal through BORROWER COMPUTING DEVICE 320 and/or INVESTOR COMPUTING DEVICE 330, respectively, that communicates with API TASKS 162 to manage their DLT TOKENS 150 or INVESTOR TOKENS 153. In one embodiment, said access may be given by proxy, for example with the user making a phone call.

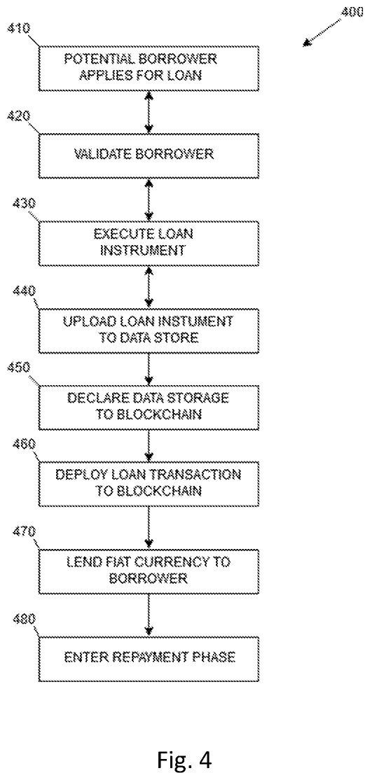

Referring to FIG. 4, an abstracted exemplary embodiment of loan origination process 400 is depicted. According to embodiments, loan origination process 400 begins at POTENTIAL BORROWER APPLIES FOR LOAN 410.

In embodiments, at POTENTIAL BORROWER APPLIES FOR LOAN 410, a prospective borrower submits an application to borrow money from a lending entity. Said application may take various forms, including an in-person application, a paper application, an electronic application, and the like. In embodiments, the application includes various demographic and credit-related information relevant to the loan desired by the applicant. In one example, the prospective borrower intends to purchase and/or improve a property with the loan proceeds. In one example, the lending entity lends money for the purchase and/or improvement of commercial properties.

According to various embodiments of POTENTIAL BORROWER APPLIES FOR LOAN 410, a loan application may request details about the subject property of the potential loan and/or the intended business purposes of the commercial property. A lending entity may request numerous and various pieces of information from the prospective borrower in order to determine the creditworthiness of the prospective borrower and ascertain the risk profile thereof.

Following POTENTIAL BORROWER APPLIES FOR LOAN 410, process flow proceeds to VALIDATE BORROWER 420. In one embodiment of VALIDATE BORROWER 420, the lending entity examines the prospective borrower, the subject property, and/or potential business uses to gain information regarding various factors as deemed appropriate and relevant to lending risk. As may be carried out with a conventional lending process, the lending entity of the present disclosure may likewise carry out a similar analysis to determine if the loan is worth the risk and, if so, what interest rate would be commensurate to the risk. Upon reaching a conclusion, the prospective borrower may be denied the loan or may be accepted at terms dictated by the lending entity.

Following VALIDATE BORROWER 420, process flow proceeds to EXECUTE LOAN INSTRUMENT 430. At embodiments of EXECUTE LOAN INSTRUMENT 430, a loan instrument is prepared for the approved borrower. In various embodiments of EXECUTE LOAN INSTRUMENT 430, the loan instrument comprises multiple agreements between the lending entity and the borrower, the entirety of which includes repayment obligations, security interest and/or mortgage agreement, and other agreements pertaining to the loan.

In one embodiment of EXECUTE LOAN INSTRUMENT 430, loan instruments are printed and hand-signed prior to scanning and further processing. In other embodiments of EXECUTE LOAN INSTRUMENT 430, loan instruments are created and signed digitally.

In one embodiment of EXECUTE LOAN INSTRUMENT 430, loan instruments are notarized and/or witnessed as may be needed to conform to laws and regulations.

Following EXECUTE LOAN INSTRUMENT 430, process flow proceeds to UPLOAD LOAN INSTRUMENT TO DATA STORE 440. After being signed and executed, loan instrument documents can be converted to a digital file format. In one example, loan instrument document files are legally equivalent Tagged Image File Format (“TIFF”) or Portable Document Format (“PDF”) files. In other examples, other file and/or image formats are used, for example PNG, JPG, etc.

In some embodiments of UPLOAD LOAN INSTRUMENT TO DATA STORE 440, the digital loan instrument files are cryptographically hashed for digital distribution. using a deterministic algorithm. In some embodiments of UPLOAD LOAN INSTRUMENT TO DATA STORE 440, the hash is published to the blockchain, thereby creating a cryptographically guaranteed tamper proof immutable digital record of the agreements that were signed, witnessed, notarized and/or printed.

In one embodiment of UPLOAD LOAN INSTRUMENT TO DATA STORE 440, the data store comprises a cloud-based data and/or file storage service. In another embodiment of UPLOAD LOAN INSTRUMENT TO DATA STORE 440, the loan instrument is stored on a server managed and/or controlled by the lending entity. In another embodiment of UPLOAD LOAN INSTRUMENT TO DATA STORE 440, the distributed ledger is treated as immutable data storage and the loan instrument is stored within the blockchain.

In embodiments of UPLOAD LOAN INSTRUMENT TO DATA STORE 440, the loan instrument(s) that were executed at EXECUTE LOAN INSTRUMENT 430 are uploaded to a data store.

In embodiments of UPLOAD LOAN INSTRUMENT TO DATA STORE 440, at the time of upload, a uniform resource locator (“URL”) link for the uploaded loan instrument may be generated and/or provided by the data store service provider. The URL link may be retained so the loan instrument may be accessed later. In one embodiment of UPLOAD LOAN INSTRUMENT TO DATA STORE 440, the URL comprises the cryptographic hash of the loan instrument file, and is therefore sufficient to identify and/or locate the loan instrument later regardless of the service provider. In one embodiment of UPLOAD LOAN INSTRUMENT TO DATA STORE 440 the URL path is the cryptographic hash of the loan instrument file. In various embodiments of UPLOAD LOAN INSTRUMENT TO DATA STORE 440, the cryptographic hash comprises the authoritative reference to the loan instrument, regardless of the protocol or URL used, supplied, provided, or distributed.

Following UPLOAD LOAN INSTRUMENT TO DATA STORE 440, process flow continues to DECLARE DATA STORAGE TO BLOCKCHAIN 450. In one embodiment of DECLARE DATA STORAGE TO BLOCKCHAIN 450, a management interface such as ADMIN MODULE 161 is used to declare the DEED LINK 120 or hash into SMART CONTRACT 101 for storage in BLOCKCHAIN STORAGE 102. In one embodiment of DECLARE DATA STORAGE TO BLOCKCHAIN 450, the storage reference key for the DEED LINK 120 is LOAN WALLET ADDRESS 110, which thus becomes associated with the loan. In one embodiment of DECLARE DATA STORAGE TO BLOCKCHAIN 450, information pertaining to the loan is published to the LOAN WALLET. In one embodiment of DECLARE DATA STORAGE TO BLOCKCHAIN 450, LOAN WALLET ADDRESS 110 comprises a subcontract under SMART CONTRACT 101.

Following DECLARE DATA STORAGE TO BLOCKCHAIN 450, process flow proceeds to DEPLOY LOAN TRANSACTION TO BLOCKCHAIN 460. In embodiments of DEPLOY LOAN TRANSACTION TO BLOCKCHAIN 460, an entry is made in the blockchain that records and memorializes the loan. Said blockchain entry may include information pertinent to the loan including, but not limited to, the principal balance, loan interest rate(s), amortization schedule, the identity of the borrower, identifying information of the property or assets that are the subject of the loan, the cryptographic hash of the loan instrument, the URL link to the loan instrument, reference documents for the promissory note, and/or any additional information that may be useful or relevant.

In embodiments of DEPLOY LOAN TRANSACTION TO BLOCKCHAIN 460 where a smart contract is used for each loan, the smart contract contains the data and is accessible at the distributed ledger technology address system for the smart contract. In embodiments of DEPLOY LOAN TRANSACTION TO BLOCKCHAIN 460 where a master smart contract is used, the master smart contract references the loan contract. In some embodiments of DEPLOY LOAN TRANSACTION TO BLOCKCHAIN 460 where a single smart contract is used, a wallet address contains the information specific to the loan, a wallet address specific to the borrower, and a wallet address specific to investor, investor pool, and/or investor smart contract.

In an embodiment of DEPLOY LOAN TRANSACTION TO BLOCKCHAIN 460, a smart contract is created on the blockchain for each individual loan. Said smart contract may include conditions relevant to the loan and may reflect whether said conditions have been satisfied or not. In one embodiment of DEPLOY LOAN TRANSACTION TO BLOCKCHAIN 460, one or more digital loan wallets are issued for a smart contract with the wallets representing the loan, permissions, balances, and/or identities of the parties involved. In another embodiment of DEPLOY LOAN TRANSACTION TO BLOCKCHAIN 460, a master smart contract interacts with a series of loan specific smart contracts, wherein each loan's smart contract represents individual agreements while the master contract is used for collaboration, communication, common rights, common roles, and/or delegated with shared assets or token.

Process flow proceeds to LEND FIAT CURRENCY TO BORROWER 470. At some embodiments of LEND FIAT CURRENCY TO BORROWER 470, the lending entity sends the principal amount to the borrower, to an escrow account on the borrower's behalf, and/or to a destination account or location as agreed upon between the lending entity and the borrower. In embodiments of LEND FIAT CURRENCY TO BORROWER 470, the loan disbursement is made in fiat currency, such as U.S. dollars or other currency as agreed upon between the lending entity and the borrower. In embodiments of LEND FIAT CURRENCY TO BORROWER 470, money that is distributed to the borrower came from a pooled amount of money that was raised by selling digital tokens to investors. In embodiments of LEND FIAT CURRENCY TO BORROWER 470, the loan disbursement is recorded on the blockchain as a transaction of the loan.

In embodiments of LEND FIAT CURRENCY TO BORROWER 470 where a prior note exists, said prior note may be assumed into the newly issued loan, as agreed upon between the lending entity and the borrower.

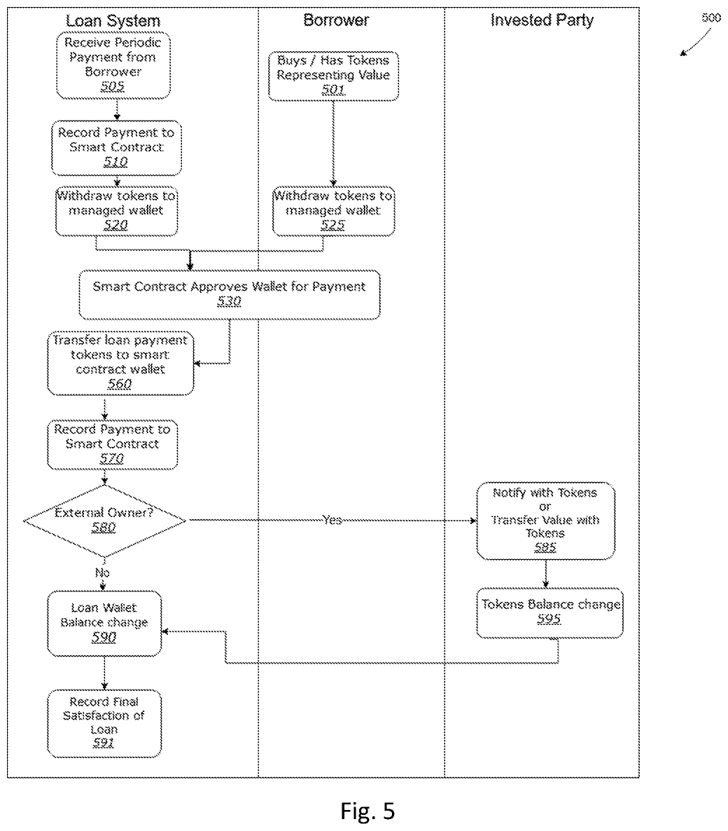

Following LEND FIAT CURRENCY TO BORROWER 470, process flow proceeds to ENTER REPAYMENT PHASE 480. In embodiments of ENTER REPAYMENT PHASE 480, the loan origination process has completed, and the borrower will begin making regular payments until the loan is paid off as illustrated in FIG. 5.

Referring to FIG. 5, an exemplary embodiment of loan repayment process 500 is depicted. According to embodiments, loan repayment process 500 begins at RECEIVE PERIODIC PAYMENT FROM BORROWER 505. At embodiments of RECEIVE PERIODIC PAYMENT FROM BORROWER 505, the borrower sends a payment according to the loan agreement and/or smart contract to the lending entity. In one embodiment of RECEIVE PERIODIC PAYMENT FROM BORROWER 505, the borrower sends the payment in the same fiat currency in which the loan was disbursed. In another embodiment of RECEIVE PERIODIC PAYMENT FROM BORROWER 505, the borrower sends the payment in digital tokens or other currencies.

In one embodiment of RECEIVE PERIODIC PAYMENT FROM BORROWER 505, a borrower can make payment in tokens, for example DLT TOKENS 150 and/or INVESTOR TOKENS 153, rather than in fiat currency. Thus, prior to doing so, the borrower can buy or otherwise obtain such tokens.

Upon receipt of RECEIVE PERIODIC PAYMENT FROM BORROWER 505, Administrator with ADMIN CONSOLE 163 or a programmatic method API TASKS 162 can RECORD PAYMENT TO SMART CONTRACT 510. In some embodiments of RECORD PAYMENT TO SMART CONTRACT 510, the payment recorded comprises the entire payment amount; in other embodiments, the payment recorded comprises principal, interest, and fees recorded separately.

In the present disclosure, the principal portion of the payment may be referred to as the “obligation portion.” In the present disclosure, the interest portion of the payment may be referred to as the “speculation portion,” meaning that portion of each payment that corresponds to an amount a lender charges a borrower for the borrowed assets. In various embodiments, the speculation portion is a proportional part of the borrower's payment that corresponds to the amount of interest accrued during the relevant time period and/or according to an amortization schedule. In embodiments, the “obligation portion” corresponds to the remaining part of the borrower's payment, after having deducted the speculation portion therefrom, that may be applied toward the loan principal and/or other obligation.

In some embodiments of RECORD PAYMENT TO SMART CONTRACT 510, the amount is recorded in fiat currency; in other embodiments, the amount is recorded using DLT TOKENS 150 or INVESTOR TOKENS 153. In some embodiments of RECORD PAYMENT TO SMART CONTRACT 510, the amount paid is converted between currency types; in other embodiments a record-keeping token may be recorded that has no intrinsic value.

In some embodiments of RECORD PAYMENT TO SMART CONTRACT 510, the BORROWER does so in fiat and/or fiat equivalent such as by check, credit card, wire transfer, cash, payment card, or other payment methods as discussed herein, and/or as known in the art at the time of filing, and/or as developed after the time of filing. In some embodiments, the BORROWER may be permitted to make their payment in DLT TOKENS 150 or INVESTOR TOKENS 153 by paying the SMART CONTRACT 101 through some WALLET MANAGEMENT MODULE 180 or other means. Such a transaction may be carried out if the BORROWER BUYS/HAS TOKENS REPRESENTING VALUE 501. If MAKES PAYMENT 171 is done by blockchain then MAKES PAYMENT 171 is a blockchain transaction interacting with BLOCKCHAIN 100. In such cases, BORROWER may optionally perform WITHDRAW TOKENS TO MANAGED WALLET 525.

WITHDRAW TOKENS TO MANAGED WALLET 525 is a method allowing COMPLIANCE MODULE 160 to work with a variety of technology and users. In cases where BORROWER does not have an appropriate BLOCKCHAIN INTERACTION MODULE 151, the limitations of their access can be bypassed by using a separate wallet. Such wallet is paid by using WITHDRAW TOKENS TO MANAGED WALLET 525 which contains the necessary functions, access and compliance. This system may also be used in cases where an exchange has a plurality of WALLET ADDRESS 103 but only the payments for a specific user are under consideration for COMPLIANCE MODULE 160. A managed wallet is an optional intermediate step for re-establishing clear ownership of specific DLT TOKENS 150 for TRANSFER LOAN PAYMENT TOKENS TO SMART CONTRACT 560.

In one embodiment of RECORD PAYMENT TO SMART CONTRACT 510, a record is made of tokens transferred. In another embodiment of RECORD PAYMENT TO SMART CONTRACT 510, a record is made of the fiat currency paid. In other embodiments, or other modes of operation for the same embodiments, the BORROWER may be permitted to transfer tokens to smart contract directly.

Upon initiation of a transfer of tokens or declaration of fiat payment, SMART CONTRACT 101 can perform SMART CONTRACT APPROVES WALLET FOR PAYMENT 530. On embodiment of SMART CONTRACT APPROVES WALLET FOR PAYMENT 530 is related to COMPLIANCE MODULE 160, and optionally PERMISSIONS 152 in order to maintain regulatory compliance. The permissions methods inside SMART CONTRACT 101 are adapted to check WALLET ADDRESS 103 of any type, including BORROWER, INVESTOR, and/or ADMINISTRATOR wallets, in order to confirm and permit the transaction.

In various embodiments of the present disclosure, in carrying out SMART CONTRACT APPROVES WALLET FOR PAYMENT 530, COMPLIANCE MODULE 160 is configured to perform one or more checks to verify that payment can be accepted. In one embodiment, the identity of BORROWER is checked against one or more whitelists of approved loan payors. In this embodiment, only approved loan payors that are present on said whitelist are allowed to make a payment. As such, if a prospective payor does not appear on the whitelist of approved loan payors, the attempted payment can be denied and/or immediately reversed. In some embodiments, the compliance is a traditional accounting practice and the results of the research done by the accounting practices are stored in software, which can be enforced or stored at SMART CONTRACT 101. In another embodiment, an artificial intelligence network or server can be queried to perform compliance checks and anti-money laundering confirmation before permitting a specific transaction or payor. If the checks are enforced at the time of transaction, then the checks are implemented by the SMART CONTRACT 101.

If SMART CONTRACT 101 confirms the WALLET ADDRESS 103 in SMART CONTRACT APPROVES WALLET FOR PAYMENT 530 successfully, then process flow may proceed to TRANSFER LOAN PAYMENT TOKENS TO SMART CONTRACT WALLET 560. In some embodiments of TRANSFER LOAN PAYMENT TOKENS TO SMART CONTRACT WALLET 560, the address used is another SMART CONTRACT 101, as a subcontract. In other embodiments of TRANSFER LOAN PAYMENT TOKENS TO SMART CONTRACT WALLET 560, the address used is a WALLET ADDRESS 103 with a private key. In various embodiments of TRANSFER LOAN PAYMENT TOKENS TO SMART CONTRACT WALLET 560, the WALLET ADDRESS 103 may also be a Non-Fungible Token address or a pool representing Non-Fungible Token ownership or rights.

Upon successful execution of TRANSFER LOAN PAYMENT TOKENS TO SMART CONTRACT WALLET 560, the process continues to RECORD PAYMENT TO SMART CONTRACT 570. In various embodiments of RECORD PAYMENT TO SMART CONTRACT 570, the payment is memorialized in BLOCKCHAIN 100 and appears in BLOCKCHAIN EXPLORER 190 as a transaction. In some embodiments, EVENT VIEWER 191 is also notified of the transaction that has occurred.

According to various embodiments of RECEIVE PERIODIC PAYMENT FROM BORROWER 505, the payment is partially allocated to repayment of the loan principal and partially allocated to payment of loan interest accrued during the relevant time period. In one embodiment of RECEIVE PERIODIC PAYMENT FROM BORROWER 505, the interest portion of the payment is allocated directly to the lending entity. In some embodiments, the amount thus paid to the lending entity may be used to pay for operating expenses and other expenses of the lending entity and/or pass to profit of the lending entity and/or its investors.

In some embodiments, the loan ownership may be represented by a loan note, a pool of investors, a Real Estate Investment Trust (“REIT”), a securities organization, a single investor, and/or some other external party not part of the lending entity that issued the loan. In embodiments where EXTERNAL OWNER 580 is true, on a per loan or per business relationship, the external party may be transferred tokens representing value or as a receipt of payment at TRANSFER VALUE WITH TOKENS 585. As a result, EXTERNAL OWNER 580 would have a balance of tokens change either up or down (depending on accounting methods) at TOKENS BALANCE CHANGES 595 and be able to manage and view those tokens by WALLET MANAGEMENT MODULE 180, BLOCKCHAIN EXPLORER 190 and/or EVENT VIEWER 191 in order to confirm transfer. In some embodiments, such components and methods optionally function as a SERVICING MODULE 192 and/or SETTLEMENT MODULE 193

If no EXTERNAL OWNER 580, the tokens are transferred to a different WALLET ADDRESS 103 wherein they represent a LOAN WALLET BALANCE CHANGE 590. In various embodiments of the present disclosure, said tokens may be reissued, reused, held in the wallet, “burned” by transfer to an irretrievable wallet, transferred or sold to exchanges, transferred or sold to marketplaces, held as a bookkeeping system, transferred to other users inside the system, or other financial arrangements as permitted by regulatory compliance and COMPLIANCE MODULE 160. In embodiments of TRANSFER LOAN PAYMENT TOKENS TO SMART CONTRACT WALLET 560, the loan payment tokens deposited at TRANSFER LOAN PAYMENT TOKENS TO SMART CONTRACT WALLET 560 or WITHDRAW TOKENS TO MANAGED WALLET 520 are transferred to the wallet(s) linked to the smart contract.

As a result of the payment being made by RECORD PAYMENT TO SMART CONTRACT 570 and LOAN WALLET BALANCE CHANGE 590, the note balance as shown in the blockchain record can be reduced to reflect the new balance owed for the loan. In one embodiment, the loan balance owed is determined by aggregating the series of blockchain records pertaining to that loan, including any principal disbursements, any completed payments, interest amounts incurred during the life of the loan, any additional fees incurred, and/or any other transactions that would add to or subtract from the amount owed.

In embodiments of the present disclosure, repayment process 500 may be repeated in whole or in part until the loan repayment schedule is satisfied and the balance owed reaches zero. In one embodiment, the borrower may be penalized for late and/or missed penalties as would be known in the art for conventional loans.

In various embodiments, upon reaching a zero balance, or an equivalent balance between the principal borrowed and the principal paid, and/or including fees and interest in the recording of any such loan arrangement, or the loan may be considered satisfied and the obligations of the borrower have been met. In such a case, process flow proceeds to RECORD FINAL SATISFACTION OF LOAN 591. In one embodiment of RECORD FINAL SATISFACTION OF LOAN 591, repayment of the loan is submitted as a transaction to the blockchain and the smart contract shows that all conditions have been met. In embodiments of RECORD FINAL SATISFACTION OF LOAN 591, the loan balance is shown in the blockchain as zero, and/or marked inactive, and/or marked paid.

In one embodiment of RECORD FINAL SATISFACTION OF LOAN 591, upon satisfaction of the loan obligations, the lending entity can file necessary documents to release any security interest such as reflected in a mortgage agreement, deed of trust, warranty document, or other security instrument. In one embodiment of RECORD FINAL SATISFACTION OF LOAN 591, such release document(s) are submitted to the blockchain. In one embodiment of RECORD FINAL SATISFACTION OF LOAN 591, such security release document(s) are submitted to a third-party publicly accessible database and a link thereto can be recorded on the blockchain. In one embodiment of RECORD FINAL SATISFACTION OF LOAN 591, a cryptographic hash of the security release document(s) is generated and uploaded to be recorded on the blockchain.

As a specific illustrative example of loan repayment process 500, assume a loan portfolio of approximately fifty million U.S. dollars ($50,000,000) has been raised from one or more investors. Further assume that the pooled portfolio is issued to one or more borrowers for one or more properties. In this example, each loan is secured by a respective security interest in the real property that corresponds to that loan.

In this specific illustrative example, and according to embodiments of the present disclosure, each borrower makes regular payments for each loan, the payment comprising an interest component and a principal component. In this example, an aggregated monthly payment for the pooled amount is three-hundred fifty-eight thousand, two-hundred fifteen U.S. dollars and fifty-three cents ($358,215.53). Of this aggregated monthly payment, the principal portion is one-hundred eleven thousand, two-hundred forty-one U.S. dollars and sixty-two cents ($111,241.62). Of the aggregated monthly payment, the interest portion is two-hundred forty-six thousand, nine-hundred seventy-three U.S. dollars and ninety-one cents ($246,973.91).

In this specific illustrative example, the interest portion is paid directly to the lending entity. The principal portion is used to purchase an equivalent quantity of digital tokens on the digital security exchange at current exchange rates. In this example, said tokens are purchased at an exchange rate of ten U.S. dollars ($10) per digital token, resulting in a purchase of approximately eleven-thousand, one-hundred twenty-four (11,124) digital tokens. In one embodiment, digital tokens may be subdivided as appropriate. These purchased digital tokens are referred to as loan payment tokens.

In this specific illustrative example, loan payment tokens are transferred to the lending entity wallet and subsequently allocated on a proportional basis to the digital wallet that corresponds to each borrower's smart contract, which causes each smart contract to reflect the repayment and satisfaction of that obligation, which in turn reduces the loan note balance of each loan.

In this specific illustrative example, the loan payment tokens are sold on the digital security exchange at a current exchange rate of eleven U.S. dollars ($11) per digital token in exchange for one-hundred twenty-two thousand, three-hundred sixty-four U.S. dollars ($122,364). This dollar amount is paid directly to the lending entity.

In this specific illustrative example, proceeds from the principal and interest payments are pooled and issued to new borrowers.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowcharts and block diagram in the attached figures illustrate the architecture, functionality, and operation of possible implementations of systems, methods, and computer program products according to various embodiments of the present disclosure. In this regard, each block in the flowcharts or block diagram may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagram block or blocks.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A method for lending, comprising:
receiving a loan application from a prospective borrower;
assessing creditworthiness of the prospective borrower;
executing a loan instrument for a loan to the borrower;
uploading a digital representation of the loan instrument to a data store;
generating a cryptographic hash of the digital representation;
causing a loan record to be generated at a first distributed ledger technology transaction record, the first transaction record comprising a reference to a token-managing distributed ledger technology smart contract, wherein the token-managing distributed ledger technology smart contract identifies a loan payment obligation and the cryptographic hash of the digital representation;
causing a loan-specific distributed ledger technology smart contract or a loan-specific digital wallet to be generated at a second distributed ledger technology transaction record, wherein said loan-specific distributed ledger technology smart contract or said loan-specific digital wallet is associated with a loan-specific digital address and with the token-managing distributed ledger technology smart contract;
issuing a loan obligation to the prospective borrower, thereby developing the prospective borrower into a borrower;
performing a compliance check or causing a compliance check to be performed, the compliance check determining if a prospective payor is approved to make a payment on behalf of the borrower;
if the prospective payor is approved to make the payment, receiving a payment from the prospective payor, the payment comprising an obligation portion and a speculation portion;
tracking the payment against the loan obligation using a digital token inside the token-managing distributed ledger technology smart contract;
causing the digital token to be transferred to the loan-specific digital address, thereby causing the token-managing distributed ledger technology smart contract to evaluate the loan obligation against a balance owed.

2. The method of claim 1, wherein the data store comprises a data storage service containing a data set having a cryptographic hash value that matches the cryptographic hash identified by the token-managing distributed ledger technology smart contract.

3. The method of claim 2, wherein the cryptographic hash is used to uniquely identify and retrieve the data set at the data storage.

4. The method of claim 1, wherein the loan instrument comprises one selected from the group consisting of: a mortgage agreement, a deed of trust, a loan note, a bond, a purchase agreement, an annuity, and a promissory note.

5. The method of claim 1, wherein the loan instrument comprises one selected from the group consisting of: a security interest to a real property, a structured payment system represented by a note or contract, a recurring payment obligation, a recurring payment receivable, a cyclical payment structure, an asset purchase by structured payment, structured rewards as recurring payments, loans based on payment percentage or sales receipt obligations, or an issued note.

6. The method of claim 1, further comprising:
issuing multiple loans to respective multiple borrowers and
associating the multiple borrowers with respective digital addresses in an ordered correlated list.

7. The method of claim 6, wherein:
each of the multiple loans is secured by a respective security interest;
each respective security interest is memorialized by a respective loan instrument;
each respective loan instrument has a respective digital representation uploaded to the data store;
each respective loan instrument digital representation has a respective unique uniform resource locator link at the data store, the uniform resource locator link comprising the cryptographic hash; and
for each of the multiple loans, the respective uniform resource locator link is included in a respective distributed ledger technology transaction record.

8. A system for lending comprising:
a computer processor and a computer memory device, wherein the system is configured to communicate with a distributed ledger technology computer system that includes multiple computing nodes, each computing node storing a copy, or a portion thereof, of a transaction history of the distributed ledger technology computer system, with the computer memory device containing computer-readable instructions directing the processor to:
receive a digital representation of an executed loan instrument, the executed loan instrument memorializing a loan agreement with a borrower;
upload the digital representation of the executed loan instrument to a data store;
generate a cryptographic hash of the digital representation;
cause a loan record to be generated at a first transaction record of the transaction history of the distributed ledger technology computer system, the first transaction record comprising a reference to a token-managing distributed ledger technology smart contract, wherein the token-managing distributed ledger technology smart contract identifies a loan payment obligation and the cryptographic hash of the digital representation;
cause a loan-specific distributed ledger technology smart contract or a loan-specific digital wallet to be generated at a second distributed ledger technology transaction record, wherein said loan-specific distributed ledger technology smart contract or said loan-specific digital wallet is associated with a loan-specific digital address and with the token-managing distributed ledger technology smart contract;
perform a compliance check or cause a compliance check to be performed, the compliance check determining if a prospective payor is approved to make a payment on behalf of the borrower;
if the prospective payor is approved to make the payment, track a payment received from the prospective payor against a loan obligation using a digital token inside the token-managing distributed ledger technology smart contract;
cause the digital token to be transferred to the loan-specific digital address, thereby causing the token-managing distributed ledger technology smart contract to evaluate the loan obligation against a balance owed.

9. The system of claim 8, wherein the data store comprises a data storage service containing a data set having a cryptographic hash value that matches the cryptographic hash identified by the token-managing distributed ledger technology smart contract.

10. The system of claim 9, wherein the cryptographic hash is used to uniquely identify and retrieve the data set at the data storage.

11. The system of claim 8, wherein the executed loan instrument comprises one selected from the group consisting of: a mortgage agreement, a deed of trust, a loan note, a bond, a purchase agreement, an annuity, and a promissory note, wherein the executed loan instrument sets forth payments.

12. The system of claim 8, wherein the loan instrument comprises one selected from the group consisting of: a security interest to a real property, a structured payment system represented by a note or contract, a recurring payment obligation, a recurring payment receivable, a cyclical payment structure, an asset purchase by structured payment, structured rewards as recurring payments, loans based on payment percentage or sales receipt obligations, or an issued note.

13. The system of claim 8, wherein the computer memory device contains computer-readable instructions directing the processor to:
issue multiple loans to respective multiple borrowers and
associate the multiple borrowers with respective digital addresses in an ordered correlated list.

14. A computer-implemented method for lending, comprising:
receiving a loan application from a prospective borrower;
assessing creditworthiness of the prospective borrower;
executing a loan instrument for a loan to the borrower;
uploading a digital representation of the loan instrument to a data store;
generating a cryptographic hash of the digital representation;
at a distributed ledger interaction module, causing a loan record to be generated at a first distributed ledger technology transaction record, the first transaction record comprising a reference to a token-managing distributed ledger technology smart contract, wherein the token-managing distributed ledger technology smart contract identifies a loan payment obligation and the cryptographic hash of the digital representation;
at the distributed ledger interaction module, causing a loan-specific distributed ledger technology smart contract or a loan-specific digital wallet to be generated at a second distributed ledger technology transaction record, wherein said loan-specific distributed ledger technology smart contract or said loan-specific digital wallet is associated with a loan-specific digital address and with the token-managing distributed ledger technology smart contract;
issuing a loan obligation to the prospective borrower, thereby developing the prospective borrower into a borrower;
performing a compliance check or causing a compliance check to be performed, the compliance check determining if a prospective payor is approved to make a payment on behalf of the borrower;
if the prospective payor is approved to make the payment, receiving a payment from the prospective payor, the payment comprising an obligation portion and a speculation portion;
at a settlement module, tracking the payment against the loan obligation using a digital token inside the token-managing distributed ledger technology smart contract;
at the distributed ledger interaction module, causing the digital token to be transferred to the loan-specific digital address, thereby causing the token-managing distributed ledger technology smart contract to evaluate the loan obligation against a balance owed.

15. The method of claim 14, wherein the data store comprises a data storage service containing a data set having a cryptographic hash value that matches the cryptographic hash identified by the token-managing distributed ledger technology smart contract.

16. The method of claim 15, wherein the cryptographic hash is used to uniquely identify and retrieve the data set at the data storage.

17. The method of claim 14, wherein the loan instrument comprises one selected from the group consisting of: a mortgage agreement, a deed of trust, a loan note, a bond, a purchase agreement, an annuity, and a promissory note, wherein the loan instrument sets forth payments.

18. The method of claim 14, wherein the loan instrument comprises one selected from the group consisting of: a security interest to a real property, a structured payment system represented by a note or contract, a recurring payment obligation, a recurring payment receivable, a cyclical payment structure, an asset purchase by structured payment, structured rewards as recurring payments, loans based on payment percentage or sales receipt obligations, or an issued note.

19. The method of claim 14, further comprising:
issuing multiple loans to respective multiple borrowers and
associating the multiple borrowers with respective digital addresses in an ordered correlated list.

20. The method of claim 19, wherein:
each of the multiple loans is secured by a respective security interest;
each respective security interest is memorialized by a respective loan instrument;
each respective loan instrument has a respective digital representation uploaded to the data store;
each respective loan instrument digital representation has a respective unique uniform resource locator link at the data store, the uniform resource locator link comprising the cryptographic hash; and
for each of the multiple loans, the respective uniform resource locator link is included in a respective distributed ledger technology transaction record.
